(19) United States
(12) Patent Application Publication
(10) Pub. No.: US 2020/0320886 A1
(43) Pub. Date: Oct. 8, 2020

(54) INFORMATION PROCESSING DEVICE, FLIGHT CONTROL INSTRUCTION METHOD, PROGRAM AND RECORDING MEDIUM

(71) Applicant: SZ DJI TECHNOLOGY CO., LTD., Shenzhen (CN)

(72) Inventor: Jiemin ZHOU, Shenzhen (CN)

(21) Appl. No.: 16/906,681

(22) Filed: Jun. 19, 2020

Related U.S. Application Data
(63) Continuation of application No. PCT/CN2018/121186, filed on Dec. 14, 2018.

(30) Foreign Application Priority Data
Dec. 26, 2017 (JP) 2017-249297

(51) Int. Cl. G08G 5/00; G05D 1/10; B64C 39/02; B64D 47/08

(52) U.S. Cl. CPC G08G 5/0039; G08G 5/0069; G08G 5/0017; B64C 2201/141; B64C 39/024; B64D 47/08; B64C 2201/127; G05D 1/106

(57) ABSTRACT

An information processing device includes a processor and a memory storing a program that, when executed by the processor, causes the processor to obtain a plurality of images photographed by a plurality of aircrafts, combine the plurality of images to generate a composite image, obtain information of a change operation for changing an image scope of the composite image, and control flight of the plurality of aircrafts based on the change operation.

### CROSS-REFERENCE TO RELATED APPLICATIONS

This application is a continuation of International Application No. PCT/CN2018/121186, filed on Dec. 14, 2018, which claims the priority to Japanese Patent Application No. 2017-249297, filed on Dec. 26, 2017, the entire contents of both of which are incorporated herein by reference.

### TECHNICAL FIELD

The present disclosure relates to the technical field of unmanned aerial vehicle technology and, more particularly, to an information processing device, a flight control instruction method, a program, and a recording medium that instruct flight control for multiple aircrafts.

### BACKGROUND

In the past, unmanned aerial vehicles (UAV) often perform aerial photographing through an on-board camera for research applications in various fields such as agriculture or disaster relief.

The existing technology includes the UAV equipped with the camera and a mobile control system with an operating device that moves a position of the UAV (referring to Patent Document 1). In the mobile control system, the operating device often includes a touch-control panel for displaying images photographed by the camera. When a user performs a touch-control operation of pinch zoom-in on the touch-control panel, the UAV moves toward a target object. When the user performs a touch-control operation of pinch zoom-out on the touch-control panel, the UAV moves away from the target object.

### PATENT LITERATURE

Patent Document 1: Japanese Patent Application Publication No. 2017-139582

### SUMMARY

In accordance with the disclosure, there is provided an information processing device including a processor and a memory storing a program that, when executed by the processor, causes the processor to obtain a plurality of images photographed by a plurality of aircrafts, combine the plurality of images to generate a composite image, obtain information of a change operation for changing an image scope of the composite image, and control flight of the plurality of aircrafts based on the change operation.

Also in accordance with the disclosure, there is provided a flight control method including obtaining a plurality of images photographed by a plurality of aircrafts, combining the plurality of images to generate a composite image, obtaining information of a change operation for changing an image scope of the composite image, and controlling a flight of the plurality of aircrafts based on the change operation.

Also in accordance with the disclosure, there is provided a computer readable recording medium storing a program that, when executed by an information processing device, causes the information processing device to: obtain a plurality of images photographed by a plurality of aircrafts; combine the plurality of images to generate a composite image; obtain information of a change operation for changing an image scope of the composite image; and control flight of the plurality of aircrafts based on the change operation.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be included in the present disclosure.

FIG. 1 is a schematic diagram of an example aircraft group control system consistent with the present disclosure.

FIG. 2A is a schematic diagram of another example aircraft group control system consistent with the present disclosure.

FIG. 2B is a schematic diagram of another example aircraft group control system consistent with the present disclosure.

FIG. 3 is a schematic diagram of an example exterior appearance of a UAV consistent with the present disclosure.

FIG. 4 is a block diagram of an example hardware configuration of the UAV consistent with the present disclosure.

FIG. 5 is a schematic diagram of an example hardware configuration of a terminal consistent with the present disclosure.

FIG. 6 schematically shows generation of a composite image based on images photographed by a plurality of UAVs consistent with the present disclosure.

FIG. 7 is a schematic diagram showing an example of performing pinch zoom-in or pinch zoom-out operation on a touch-control panel of the terminal to enlarge or reduce an image scope of the composite image consistent with the present disclosure.

FIG. 8 is a schematic diagram showing another example of performing pinch zoom-in or pinch zoom-out operation on a touch-control panel of the terminal to enlarge or reduce the image scope of the composite image consistent with the present disclosure.

FIG. 9 is a schematic diagram showing an example of calculating a distance that each of the plurality of UAVs moves when a user performs the pinch zoom-in operation or the pinch zoom-out operation to move each of the plurality of UAVs in a horizontal direction consistent with the present disclosure.

FIG. 10 is a schematic diagram of a configuration screen of an operation mode consistent with the present disclosure.

FIG. 11 is a schematic diagram showing an example of performing a twist operation on the touch-control panel to rotate the image scope of the composite image consistent with the present disclosure.

FIG. 12 is a schematic diagram showing an example of calculating a rotation angle rotated by the UAV group corresponding to a twist operation by the user consistent with the present disclosure.

FIG. 13 is a schematic diagram showing an example of performing a sliding operation on the touch-control panel (TP) to move the UAV group consistent with the present disclosure.

FIG. 14 is a schematic diagram of an example operation sequence of the terminal and each of the plurality of UAVs consistent with the present disclosure.

### DESCRIPTION OF REFERENCE NUMERALS

10 Unmanned aerial vehicle (UAV) group control system
50 Transmitter
80 Terminal
81 Terminal controller
83 Operation device
85 Communication device
87 Memory
88 Display
89 Storage device
100 UAV
100G UAV group
102 UAV main body
110 UAV controller
150 Communication interface
160 Memory
170 Storage device
200 Gimbal
210 Rotor mechanism
220, 230 Camera
240 GPS receiver
250 Inertia measure unit (IMU) device
260 Compass
270 Barometric altimeter
280 Ultrasonic sensor
290 Laser measurement instrument
SA Image scope of a composite image

### DETAILED DESCRIPTION OF THE EMBODIMENTS

Embodiments of the present disclosure are described in detail below with reference to the accompanying drawings. Same or similar reference numerals in the drawings represent the same or similar elements or elements having the same or similar functions throughout the specification. It will be appreciated that the described embodiments are some rather than all of the embodiments of the present disclosure. Other embodiments obtained by those having ordinary skills in the art on the basis of the described embodiments without inventive efforts should fall within the scope of the present disclosure.

In the following embodiments, an unmanned aerial vehicle (UAV) is illustrated as an example of an aircraft. The unmanned aerial vehicle includes an aircraft moving in the air. In the specification and the accompany drawings, the unmanned aerial vehicle is referred to as “UAV.” In addition, a terminal is illustrated as an example of an information processing device. Further, the information processing device includes, but is limited to, a mobile terminal, a personal computer, or a proportional controller. Further, a recording medium records programs, such as programs causing the information processing device to perform various processing.

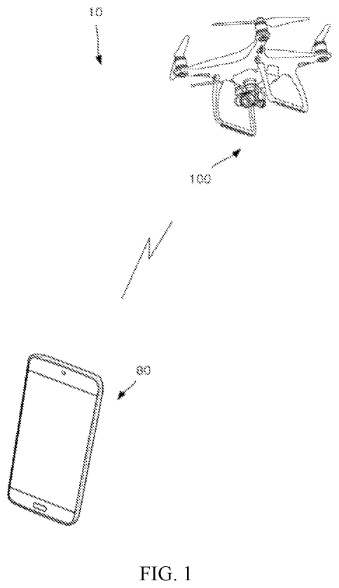

FIG. 1 is a schematic diagram of an example of an aircraft group control system 10 consistent with the present disclosure. As shown in FIG. 1, the aircraft group control system 10 includes an unmanned aerial vehicle (UAV) 100 and a terminal 80. The UAV 100 and the terminal 80 communicate with each other through wired communication or wireless communication (e.g., a wireless local area network). In the example shown in FIG. 1, the terminal 80 is a mobile terminal (e.g., a smart phone, a tablet computer). The terminal 80 is an example of an information processing device.

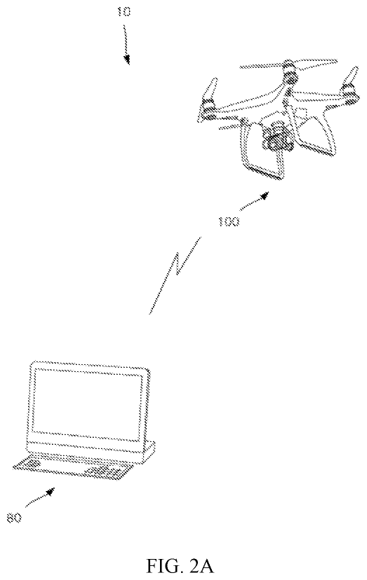

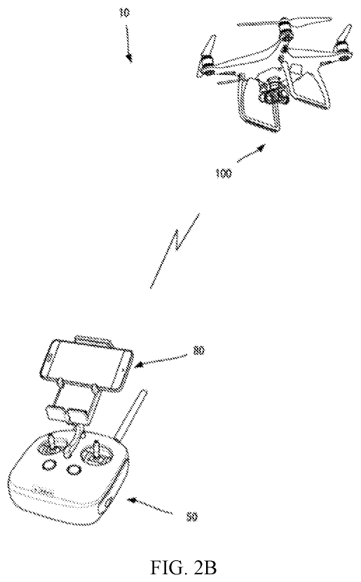

FIG. 2A is a schematic diagram of another example of the aircraft group control system 10 consistent with the present disclosure. In the example shown in FIG. 2A, the terminal 80 is a personal computer (PC). In either FIG. 1 or FIG. 2A, the terminal 80 has the same functions.

FIG. 2B is a schematic diagram of another example of the aircraft group control system 10 consistent with the present disclosure. As shown in FIG. 2B, the aircraft group control system 10 includes the UAV 100, a transmitter 50, and the terminal 80. The UAV 100, the transmitter 40, and the terminal 80 communicate with each other through wired communication or wireless communication. In addition, the terminal 80 may or may not communicate with the UAV 100 through the transmitter 50.

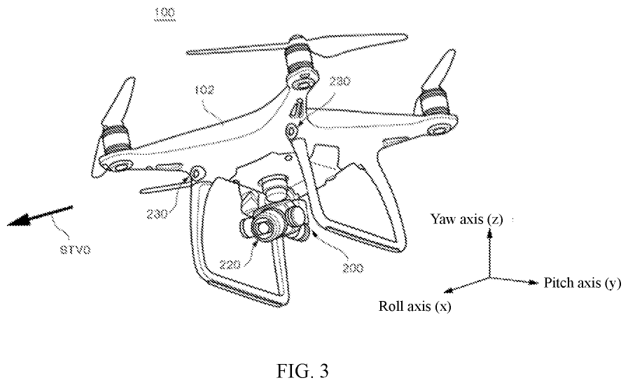

FIG. 3 is a schematic diagram of an example exterior appearance of the UAV 100 consistent with the present disclosure. FIG. 3 illustrates a perspective view of the UAV 100 flying in a movement direction STV0. The UAV 100 is an example of an aircraft.

As shown in FIG. 3, a roll axis (referred to as x axis) is defined as a direction parallel to the ground and along the movement direction STV0. In this case, a pitch axis (referred to as y axis) is defined as a direction parallel to the ground and perpendicular to the roll axis. Further, a yaw axis (referred to as z axis) is defined as a direction perpendicular to the ground and perpendicular to both the roll axis and the pitch axis.

The UAV 100 includes a UAV main body 102, a gimbal 200, a camera 220, and a plurality of cameras 230.

The UAV main body 102 includes a plurality of rotors (propellers). The UAV main body 102 causes the UAV 100 fly by controlling the plurality of rotors to rotate. The number of the plurality of rotors is, e.g., 4, but not limited to 4. In some other embodiments, the UAV 100 may be a fixed wing aircraft without any rotor.

The camera 220 is a photographing camera for photographing any target objects (e.g., a scene of sky, a landscape of mountains, a building on the ground) included in an expected photographing range.

The plurality of cameras 230 include sensing cameras for photographing surroundings of the UAV 100 in order to control the flight of the UAV 100. Two cameras 230 may be arranged at the front of the UAV 100. Furthermore, another two cameras 230 may be arranged at the bottom of the UAV 100. The two cameras 230 at the front are paired to photograph three-dimensional (3D) images. The two cameras 230 at the bottom are also paired to photograph three-dimensional (3D) images. Images photographed by the plurality of cameras 230 are used to generate 3D spatial data surrounding the UAV 100. In addition, the number of the plurality of cameras 230 included in the UAV 100 is not limited to 4. The UAV 100 can include at least one camera 230. The UAV 100 may include at least one camera 230 at each of the front, the rear, the two sides, the bottom, and the top. A viewing angle of each of the plurality of cameras 230 may be larger than a viewing angle of the camera 220. Each of the plurality of cameras 230 may have a single focus lens, a fisheye lens, or a zoom lens.

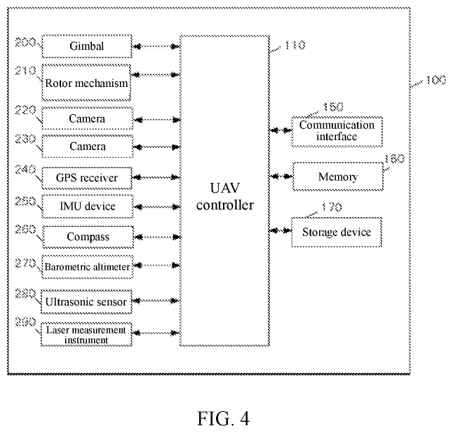

FIG. 4 is a block diagram of example hardware configuration of the UAV 100 consistent with the present disclosure. As shown in FIG. 4, the UAV 100 includes a UAV controller 110, a communication interface 150, a memory 160, a storage device 170, a gimbal 200, a rotor mechanism 210, a camera 220, a plurality of cameras 230, a GPS receiver 240, an IMU device 250, a compass 260, a barometric altimeter 270, an ultrasonic sensor 280, and a laser measurement instrument 290.

The UAV controller 110 includes a central processing unit (CPU), a micro processing unit (MPU), or a digital signal processor (DSP). The UAV controller 110 performs signal processing for overall control of operations of various modules of the UAV 100, data input output processing between various modules, data computing processing, and data storage processing.

The UAV controller 110 executes programs stored in the memory 160 to control the flight of the UAV 100. The UAV controller 110 controls the flight according to flight control instructions sent by the transmitter 50 or the terminal 80. UAV controller 110 controls the camera 220 or each of the plurality of cameras 230 to photograph images.

The UAV controller 110 obtains position information indicating a position of the UAV 100. The UAV controller 110 obtains the position information indicating latitude, longitude, and altitude where the UAV 100 is located from the GPS receiver 240. The UAV controller 110 may use the latitude information and the longitude information indicating the latitude and the longitude of the UAV 100 and obtained from the GPS receiver 240 as the position information and use the altitude information indicating the altitude of the UAV 100 and obtained from the barometric altimeter 270 as the position information. The UAV controller 110 may obtain a distance between an ultrasonic transmission point of the ultrasonic sensor 280 and an ultrasonic reflection point as the altitude information.

The UAV controller 110 obtains attitude information indicating an attitude of the UAV 100 from the compass 260. The attitude information may be, for example, orientation of the head of the UAV 100.

The UAV controller 110 may obtain the position information indicating the position where the UAV 100 is supposed to be located when the camera 220 is supposed to photograph the target objects in the photographing range. The UAV controller 110 may obtain the position information indicating the position where the UAV 100 is supposed to be located from the memory 160. The UAV controller 110 may obtain the position information indicating the position where the UAV 100 is supposed to be located from other devices through the communication interface 150. The UAV controller 110 may obtain the position information indicating the position where the UAV 100 is supposed to be located by referring to a 3D map database to determine a candidate position of the UAV 100.

The UAV controller 110 obtains the photographing range information indicating the photographing ranges of the camera 220 and each of the plurality of cameras 230, respectively. The UAV controller 110 obtains viewing angle information indicating the viewing angles of the camera 220 and each of the plurality of cameras 230 from the camera 220 and each of the plurality of cameras 230, respectively, as parameters for determining the photographing range. The UAV controller 110 obtains information indicating photographing directions of the camera 220 and each of the plurality of cameras 230, respectively, as parameters for determining the photographing range. The UAV controller 110 obtains the attitude information indicating the attitude of the camera 220 from the gimbal 200, as the information indicating the photographing direction of the camera 220. The attitude information of the camera 220 indicates a rotation angle reflecting reference rotation angles of the pitch axis and the yaw axis of the gimbal 200.

The UAV controller 110 obtains the position information indicating the position of the UAV 100 as the parameters for determining the photographing range. Based on the viewing angles and the photographing directions of the camera 220 and each of the plurality of cameras 230, and the position where the UAV 100 is located, the UAV controller 110 may define the photographing range indicating a geographical range photographed by the camera 220 and generate the photographing range information. Thus, the photographing range information is obtained.

The UAV controller 110 may obtain the photographing range information from the memory 160. The UAV controller 110 may obtain the photographing range information through the communication interface 150.

The UAV controller 110 controls the gimbal 200, the rotor mechanism 210, the camera 220, and the plurality of cameras 230. The UAV controller 110 may control the photographing range of the camera 220 by adjusting the photographing direction or the view angle of the camera 220. The UAV controller 110 may control the photographing range of the camera 220 mounted on the gimbal 200 by controlling a rotation mechanism of the gimbal 200.

The photographing range refers to the geographical range photographed by the camera 220 or each of the plurality of cameras 230. The photographing range id defined by the latitude, the longitude, and the altitude. The photographing range may be a range in the 3D spatial data defined by the latitude, the longitude, and the altitude. The photographing range may be a range in the two-dimensional (2D) spatial data defined by the latitude and the longitude. The photographing range may be determined based on the viewing angles and the photographing directions of the camera 220 or each of the plurality of cameras 230, and the position where the UAV 100 is located. The photographing direction of the camera 220 or each of the plurality of cameras 230 is defined based on the attitude and pitch angle where the front of the camera 220 or each of the plurality of cameras 230 is facing. The photographing direction of the camera 220 is a direction determined according to the orientation of the head of the UAV 100 and the attitude state of the camera 220 relative to the gimbal 200. The photographing direction of each of the plurality of cameras 230 is a direction determined according to the orientation of the head of the UAV 100 and the mounting position of each of the plurality of cameras 230.

The UAV controller 110 determines the surrounding environment of the UAV 100 by analyzing a plurality of images photographed by the plurality of cameras 230. The UAV controller 110 controls the flight and avoids obstacles based on the surrounding environment of the UAV 100.

The UAV controller 110 may obtain 3D information indicating a 3D shape of an object surrounding the UAV 100. The object may be a portion of a landscape including a building, a road, a vehicle, and a tree, etc. The 3D information may be 3D spatial data. The UAV controller 110 obtains the plurality of images from the plurality of cameras 230 to generate the 3D information indicating the 3D shapes of the objects surrounding the UAV 100. The UAV controller 110 may obtain the 3D information indicating the 3D shapes of the objects surrounding the UAV 100 by referring to the 3D map database stored in the memory 160 or the storage device 170. The UAV controller 110 may obtain the 3D information related to the 3D shapes of the objects surrounding the UAV 100 by referring to the 3D map database managed by a networked server.

The UAV controller 110 controls the flight of the UAV 100 by controlling the rotor mechanism 210. That is, the UAV controller 110 controls the position of the UAV 100 including the latitude, the longitude, and the altitude by controlling the rotor mechanism 210. The UAV controller 110 controls the photographing range of the camera 220 by controlling the flight of the UAV 100. The UAV controller 110 may control the viewing angle of the camera 220 by controlling the zoom lens of the camera 220. The UAV controller 110 may control the viewing angle of the camera 220 by using a digital zooming function of the camera 220 to digitally vary the focus.

When the camera 220 is fixed to the UAV 100 and the camera 220 is not movable, the UAV controller 110 can control the camera 220 to photograph images in the expected photographing range in the expected environment by moving the UAV 100 to the particular position at the particular time. Alternatively, even if the camera 220 does not have the zooming function and is unable to vary the viewing angle of the camera 220, the UAV controller 110 can still control the camera 220 to photograph images in the expected photographing range in the expected environment by moving the UAV 100 to the particular position at the particular time.

The communication interface 150 communicates with the terminal 80 or the transmitter 50. The communication interface 150 may perform wireless communication using any wireless communication methods. The communication interface 150 may perform wired communication using any wired communication methods. The communication interface 150 may transmit photographed images and additional information (metadata) related to the photographed images to the terminal 80 or the transmitter 50. The additional information may also include information related to the photographing range.

The memory 160 stores the programs for the UAV controller 110 to control the gimbal 200, the rotor mechanism 210, the camera 220, the plurality of cameras 230, the GPS receiver 240, the IMU device 250, the compass 260, the barometric altimeter 270, the ultrasonic sensor 280, and the laser measurement instrument 290. The memory 160 may be a computer readable recording medium and may include at least one of a static random access memory (SRAM), a dynamic random access memory (DRAM), an erasable programmable read only memory (EPROM), an electrically erasable programmable read only memory (EEPROM), or a USB memory. The memory 160 may be removed from the UAV main body 102. The memory 160 may operate as a task memory.

The storage device 170 may include at least one of a hard disk drive (HDD), a solid state drive (SSD), an SD card, a USB memory, or other storage device. The storage device 170 stores various information and data. The storage device 170 may also be removed from the UAV main body 102. The storage device 170 may record the photographed images or the composite image.

The gimbal 200 supports the camera 220 to rotate around the yaw axis, the pitch axis, and the roll axis. The gimbal 200 changes the photographing direction of the camera 220 by rotating the camera 220 around at least one of the yaw axis, the pitch axis, or the roll axis.

The rotor mechanism 210 includes a plurality of rotors and a plurality of drive motors that rotate the plurality of rotors. The rotor mechanism 210 flies the UAV 100 by rotating under the control of the UAV controller 110. The plurality of rotors 211 may include, for example, four rotors, or may include a different number of rotors. The more the plurality of rotors 211, the greater the lifting power of the UAV 100.

The GPS receiver 240 receives multiple signals indicating the time transmitted from multiple navigation satellites and the positions (coordinates) of the respective GPS satellites. Based on the received signals, the GPS receiver 240 calculates the position of the GPS receiver 240 (i.e., the position of the UAV 100). The GPS receiver 240 sends the position information of the UAV 100 to the UAV controller 110. In addition, the calculation of the position information of the GPS receiver 240 may be performed by the UAV controller 110 instead of the GPS receiver 240. In this case, the information indicating the transmitting time and the position of multiple GPS satellites in the multiple signals received by the GPS receiver 240 is sent to the UAV controller 110.

The IMU device 250 detects the attitude of the UAV 100 and sends the detected result to the UAV controller 110. The IMU device 250 may detect the acceleration in the three axes including a front-rear axis, a left-right axis, and a top-bottom axis of the UAV 100 and the angular velocities in the three axes including the pitch axis, the roll axis, and the yaw axis, as the attitude of the UAV 100.

The compass 260 detects the orientation of the head of the UAV 100 and sends the detected result to the UAV controller 110.

The barometric altimeter 270 detects the flying altitude of the UAV 100 and sends the detected result to the UAV controller 110.

The ultrasonic sensor 280 transmits an ultrasonic signal, detects the ultrasonic signal reflected by the ground or an object, and sends the detected result to the UAV controller 110. The detected result may indicate a distance between the UAV 100 and the ground, that is, the altitude. The detected result may indicate a distance between the UAV 100 and the object (the target object).

The laser measurement instrument 290 emits a laser light, receives the laser light reflected by the object, and uses the reflected laser light to measure the distance between the UAV 100 and the object (the target object). For example, the method of the laser distance measurement may be a time-of-flight method.

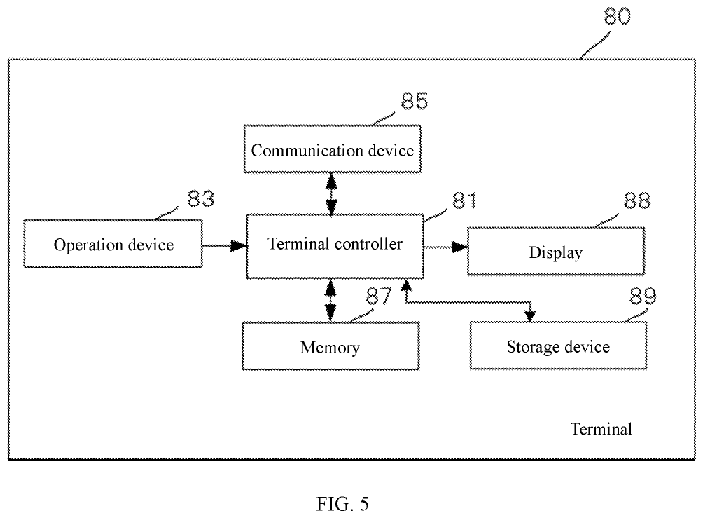

FIG. 5 is a schematic diagram of an example hardware configuration of a terminal 80 consistent with the present disclosure. As shown in FIG. 5, the terminal 80 includes a terminal controller 81, an operation device 83, a communication device 85, a memory 97, a display 88, and a storage device 89. The terminal 80 may be handheld by a user who intends to provide instructions to control the flight of a plurality of UAVs 100.

The terminal controller 81 includes a CPU, an MPU, or a DSP. The terminal controller 81 performs signal processing for overall control of operations of various modules of the terminal 80, data input output processing between various modules, data computing processing, and data storage processing.

The terminal controller 81 obtains data or information (e.g., various measurement data, image data, position information of the UAV 100) from the UAV 100 through the communication device 85. The terminal controller 81 may also obtain data or information inputted from the operation device 83. The terminal controller 81 may also obtain data or information stored in the memory 87. The terminal controller 81 may also transmit data or information to the UAV 100 through the communication device 85. The terminal controller 81 may also output data or information to the display 88 for displaying display information based on the data or information.

The terminal controller 81 may also execute an application to provide instructions to control the flight of the plurality of UAVs 100 (also known as UAV group 100G). The terminal controller 81 may also generate various data used in the application.

The operation device 83 accepts and obtains the data or information inputted by the user of the terminal 80. The operation device 83 may also include input devices such as a button, a key, a touch screen, and a microphone, etc. For example, the operation device 83 and the display 88 include a touch-control panel (TP). In this case, the operation device 83 may accept a touch-control operation, a tap operation, a drag operation, a pinch zoom-out operation, a pinch zoom-in operation, a twist operation, and a slide operation, etc. The information inputted by the operation device 83 may be transmitted to the UAV 100.

The communication device 85 wirelessly communicates with the UAV 100 using various wireless communication. The wireless communication may include wireless local area network, Bluetooth (registered trade mark), or public wireless channels. The communication device 85 may perform wired communication using any wired communication methods.

The memory 87 may include a ROM for storing the programs for instructing the operations of the terminal 80 and a RAM for temporarily storing various information or data used in the processing performed by the terminal controller 81. The memory 87 may also include memories other than the ROM and the RAM. The memory 87 may be configured inside the terminal 80. The memory 87 may be removed from the terminal 80. The programs may include the application program.

The display 88 may include, for example, a liquid crystal display (LCD) for displaying various information or data outputted from the terminal controller 81. The display 88 may also display various data or information related to the execution of the application.

The storage device 89 stores and saves various data and information. The storage device 89 may be a HDD, an SSD, an SD card, or a USB memory. The storage device 89 may also be configured inside the terminal 80. The storage device 89 may be removed from the terminal 80. The storage device 89 may save the photographed images, the composite image, or the additional information obtained from the UAV 100. The additional information may be saved in the memory 87.

In addition, the detailed description of the transmitter 50 (referring to FIG. 2B) is omitted as the transmitter 50 may have similar components as the terminal 80. The transmitter 50 includes a controller, an operation device, a communication device, and a memory, etc. The operation device may include a steering stick (control stick) for controlling the flight of the UAV 100. The transmitter 50 also includes a display for displaying various information. The transmitter 50 also includes at least a portion of the functions performed by the terminal 80. In this case, the terminal 80 may be omitted.

Next, functions related to controlling the flight of the UAV group 100G including a plurality of UAVs 100 are described.

The terminal controller 81 of the terminal 80 performs the processing related to instructing to control the flight of the UAV group 100G. The UAV group 100G includes the plurality of UAVs 100 that are coordinated to fly together. The camera 220 or each of the plurality of cameras 230 of each of the plurality of UAVs 100 in the UAV group 100G performs photographing (aerial photographing) of the ground (a direction along the direction of gravity). The UAV controller 110 of each of the plurality of UAVs 100 transmits the image data photographed by the camera 220 or each of the plurality of cameras 230 to the terminal 80 through the communication interface 150. In addition, the camera 220 or each of the plurality of cameras 230 may have a single focus lens with a fixed viewing angle (single lens) or a variable focus lens.

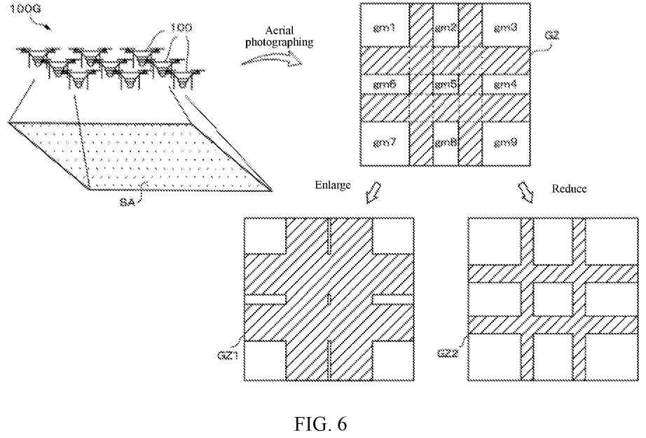

FIG. 6 schematically shows the generation of a composite image based on images photographed by the plurality of UAVs 100 consistent with the present disclosure. Through the communication device 85, the terminal controller 81 of the terminal 80 receives image data from the plurality of UAVs 100 of the UAV group 100G and stores the image data in the memory 87. Based on the plurality of images gm1-gm9 photographed by the UAV group 100G, the terminal controller 81 generates a composite image GZ. In the composite image GZ, an area indicated by diagonal lines is a portion where two or more of the plurality of images gm1-gm9 overlap. The composite image GZ may be, for example, a panoramic image, a distance image, a stereoscopic image, or a 3D image, etc.

An area enclosed by a periphery surrounding the composite image GZ is an image scope SA of the composite image GZ. The image scope SA may be an area enclosed by a line continuously connecting the outermost portions of contours of the plurality of images gm1-gm9. The image scope SA is determined based on the photographing ranges of the images photographed by the plurality of UAVs 100. The information of the photographing range is included in the additional information transmitted from each of the plurality of UAVs 100 to the terminal 80.

When the terminal controller 81 changes the image scope of the composite image GZ obtained based on the plurality of images gm1-gm9 photographed by the UAV group 100G, the terminal controller 81 provides various movement control instructions to the UAV group 100G as illustrated in the following operation embodiments. For example, through instructing the plurality of UAVs 100 in the UAV group 100G to move, the terminal controller 81 obtains the composite image GZ1 with an enlarged image scope SA or the composite image GZ2 with a reduced image scope SA.

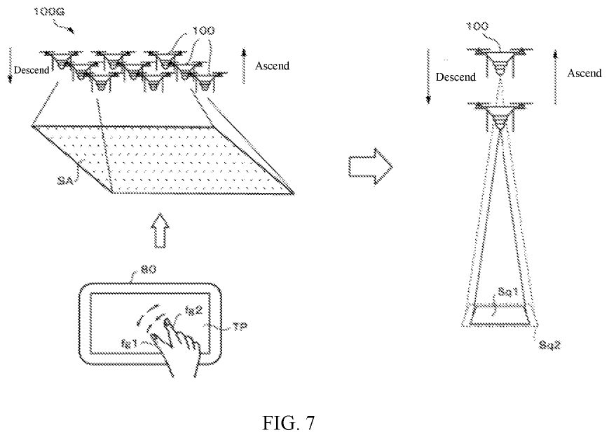

FIG. 7 is a schematic diagram showing an example of performing pinch zoom-in or pinch zoom-out operation on a touch-control panel TP of the terminal 80 to enlarge or reduce an image scope SA of the composite image consistent with the present disclosure. In the example shown in FIG. 7, the terminal controller 81 controls the plurality of UAVs 100 in the UAV group 100G to rise in response to a pinch zoom-out operation. In addition, the terminal controller 81 also controls the plurality of UAVs 100 in the UAV group 100G to descend in response to a pinch zoom-in operation. The pinch zoom-out operation and the pinch zoom-in operation are some of the change operations for changing the image scope SA of the composite image.

In the pinch zoom-out operation or the pinch zoom-in operation, for example, the terminal controller 81 obtains information inputted at two positions of the touch-control panel (TP) at two time points, and calculates a distance between the two inputted positions at the two time points. When the distance at the latter of the two time points is greater than the distance at the former of the two tie points, the terminal controller 81 detects the pinch zoom-in operation. When the distance at the latter of the two time points is smaller than the distance at the former of the two tie points, the terminal controller 81 detects the pinch zoom-out operation.

The user performs the pinch zoom-out operation by using two fingers (e.g., a thumb fg1 and an index finger fg2) to touch the touch-control panel TP and to move the two fingers close to each other. The terminal controller 81 detects the pinch zoom-out operation and an operation amount through the touch-control panel TP. After detecting the pinch zoom-out operation, the terminal controller 81 calculates an ascent distance corresponding to the operation amount. The ascent distance can be a movement distance that each of the plurality of UAVs 100 ascends to raise the flight altitude thereof. For example, the greater the operation amount, the longer the ascent distance. The smaller the operation amount, the shorter the ascent distance.

Through the communication device 85, the terminal controller 81 transmits instruction information for instructing to ascend by the calculated ascent distance to each of the plurality of UAVs 100 in the UAV group 100G. The UAV controller 110 of each of the plurality of UAVs 100 in the UAV group 100G receives the instruction information through the communication interface 150. According to the received instruction information, the UAV controller 110 drives the rotor mechanism 210 to control each of the plurality of UAVs 100 to ascend by the ascent distance corresponding to the operation amount of the pinch zoom-out operation.

In addition, the flight altitudes of the plurality of UAVs 100 in the UAV group 100G may be the same or different before the pinch zoom-out operation. However, the ascent distance is the same for each of the plurality of UAVs 100. That is, a changing amounts of the altitudes of the plurality of UAVs 100 are the same. In addition, the changing amounts of the altitudes of the plurality of UAVs 100 may also be different.

The photographing range of the camera 220 of each of the plurality of UAVs 100 may be enlarged, for example, from an area Sq1 to an area Sq2 due to the ascending of each of the plurality of UAVs 100. As a result, the image scope SA of the composite image generated based on the images photographed by the plurality of UAVs 100 in the UAV group 100G is wider than before the ascending.

The user performs the pinch zoom-in operation by using two fingers (e.g., the thumb fg1 and the index finger fg2) to touch the touch-control panel TP and to move the two fingers away from each other. The terminal controller 81 detects the pinch zoom-in operation and an operation amount through the touch-control panel TP. After detecting the pinch zoom-in operation, the terminal controller 81 calculates a descent distance corresponding to the operation amount. The descent distance can be a movement distance that each of the plurality of UAVs 100 descends to lower the flight altitude thereof. For example, the greater the operation amount, the longer the descent distance. The smaller the operation amount, the shorter the descent distance.

Through the communication device 85, the terminal controller 81 transmits instruction information for instructing to descend by the calculated descent distance to each of the plurality of UAVs 100 in the UAV group 100G. The UAV controller 110 of each of the plurality of UAVs 100 in the UAV group 100G receives the instruction information through the communication interface 150. According to the received instruction information, the UAV controller 110 drives the rotor mechanism 210 to control each of the plurality of UAVs 100 to descend by the descent distance corresponding to the operation amount of the pinch zoom-in operation.

In addition, the flight altitudes of the plurality of UAVs 100 in the UAV group 100G may be the same or different before the pinch zoom-in operation. However, the descent distance is the same for each of the plurality of UAVs 100. That is, changing amounts of the altitudes of the plurality of UAVs 100 are the same. In addition, the changing amounts of the altitudes of the plurality of UAVs 100 may also be different.

The photographing range of the camera 220 of each of the plurality of UAVs 100 may be reduced, for example, from the area Sq2 to the area Sq1 due to the descending of each of the plurality of UAVs 100. As a result, the image scope SA of the composite image generated based on the images photographed by the plurality of UAVs 100 in the UAV group 100G is narrower than before the descending.

Compared with a horizontal movement of the plurality of UAVs 100 in the UAV group 100G, when the UAV group 100G ascends or descends to change the altitudes, the image range of the images photographed by the camera 220 of each of the plurality of UAVs 100 changes less. In this case, the terminal 80 may use the pinch zoom-out operation or the pinch zoom-in operation to slightly adjust the photographing range of the camera 220 of each of the plurality of UAVs 100. As such, the image scope SA of the composite image can be slightly adjusted.

In addition, when the user performs the pinch zoom-out operation or the pinch zoom-in operation, the terminal controller 81 may not only detect the operation of the finger movement and the operation amount (operation range), but also detect a speed of the finger movement, through the operation device 83. When the terminal controller 81 detects the speed of the finger movement, the speed can be included in the instruction information transmitted to each of the plurality of UAVs 100 in the UAV group 100G, such that each of the plurality of UAVs 100 in the UAV group UAVG ascends or descends at a speed corresponding to the speed of the finger movement. Through the communication interface 150, the UAV controller 110 of each of the plurality of UAVs 100 in the UAV group 100G receives the instruction information. According to the received instruction information, the UAV controller 110 controls the corresponding UAV 100 to ascend or descend at the speed corresponding to the speed of the finger movement. As such, in response to the user's operation, the terminal 80 can arbitrarily change the speed at which the image scope SA of the composite image changes.

In this way, the terminal controller 81 obtains the information of the pinch zoom-out operation or the pinch zoom-in operation (an example of the change operation) that changes the image scope SA of the composite image (an example of the first image scope). Based on the pinch zoom-out operation or the pinch zoom-in operation, the terminal controller 81 instructs the plurality of UAVs 100 to move in a direction (an altitude direction) perpendicular to the horizontal direction. The instruction is an example of the first movement instruction.

Correspondingly, because the terminal 80 controls the plurality of UAVs 100 to move in the altitude direction, the image scope SA of the composite image changes less than the horizontal movement of the plurality of UAVs 100, and slight adjustment is feasible. For example, when the horizontal movement of the plurality of UAVs 100 is restricted and the plurality of UAVs 100 is unable to move in the horizontal direction, it is still possible to change the image scope SA.

In addition, the terminal controller 81 may instruct to control the flight of the plurality of UAVs 100, such that each of the plurality of UAVs 100 moves the same distance in the altitude direction. As a result, the size relationship of the photographing ranges of the images photographed by the plurality of UAVs 100 is difficult to be maintained before and after the change operation, the terminal 80 can still maintain the image quality in the image scope SA of the composite image generated based on the photographed images.

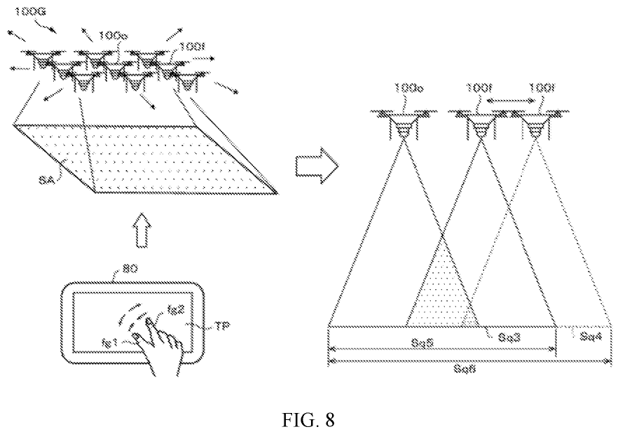

FIG. 8 is a schematic diagram showing an example of performing pinch zoom-in or pinch zoom-out operation on a touch-control panel TP of the terminal 80 to enlarge or reduce the image scope SA of the composite image consistent with the present disclosure. In the example shown in FIG. 8, according to the pinch zoom-out operation, the terminal controller 81 controls the UAV group 100G to expand in the horizontal direction. In addition, according to the pinch zoom-in operation, the terminal controller 81 controls the UAV group 100G to contract in the horizontal direction.

In this disclosure, the expansion of the UAV group 100G refers to that gaps between the plurality of UAVs 100 in the UAV group 100G increase. In other words, a real space occupied by the UAV group 100G expands. The contraction of the UAV group 100G refers to that the gaps between the plurality of UAVs 100 in the UAV group 100G decrease. In other words, the real space occupied by the UAV group 100G contracts.

The user performs the pinch zoom-out operation on the touch-control panel TP. The terminal controller 81 detects the pinch zoom-out operation and the operation amount through the operation device 83. After detecting the pinch zoom-out operation, the terminal controller 81 calculates an expansion distance corresponding to the operation amount. The expansion distance can be a movement distance that each of the plurality of UAVs 100 moves to increase the gaps between adjacent UAVs 100. For example, the greater the operation amount, the longer the expansion distance. The smaller the operation amount, the shorter the expansion distance.

Through the communication device 85, the terminal controller 81 transmits the instruction information for instructing to expand by the calculated expansion distance to the UAV group 100G. Each of the plurality of UAVs 100 in the UAV group 100G receives the instruction information through the communication interface 150. According to the received instruction information, the UAV controller 110 controls each of the plurality of UAVs 100 to move in the horizontal direction by the expansion distance corresponding to the operation amount of the pinch zoom-out operation.

For example, with respect to a UAV 100o at the center of the plurality of UAVs 100 in the UAV group 100G, the photographing range of a UAV 100f changes from an area Sq3 to an area Sq4 due to the movement of the UAV 100f. As a result, the photographing range of the two UAVs 100o and 100f expands from an area Sq5 to an area Sq6. Thus, the image scope SA of the composite image generated based on the plurality of images photographed by the plurality of UAVs 100 in the UAV group 100G expands as compared to before the expansion of the UAV group 100G.

The user performs the pinch zoom-in operation on the touch-control panel TP. The terminal controller 81 detects the pinch zoom-in operation and the operation amount through the operation device 83. After detecting the pinch zoom-in operation, the terminal controller 81 calculates a contraction distance corresponding to the operation amount. The contraction distance can be a movement distance that each of the plurality of UAVs 100 moves to decrease the gaps between adjacent UAVs 100. For example, the greater the operation amount, the longer the contraction distance. The smaller the operation amount, the shorter the contraction distance.

Through the communication device 85, the terminal controller 81 transmits the instruction information for instructing to contract by the calculated contraction distance to the UAV group 100G. Each of the plurality of UAVs 100 in the UAV group 100G receives the instruction information through the communication interface 150. According to the received instruction information, the UAV controller 110 controls each of the plurality of UAVs 100 to move in the horizontal direction by the contraction distance corresponding to the operation amount of the pinch zoom-in operation.

For example, with respect to the UAV 100o at the center of the plurality of UAVs 100 in the UAV group 100G, the photographing range of the UAV 100f changes from the area Sq4 to the area Sq3 due to the movement of the UAV 100f. As a result, the photographing range of the two UAVs 100o and 100f contracts from the area Sq6 to the area Sq5. Thus, the image scope SA of the composite image generated based on the plurality of images photographed by the plurality of UAVs 100 in the UAV group 100G contracts as compared to before the contraction of the UAV group 100G.

Compared with the movement in the altitude direction (the gravity direction, the direction perpendicular to the horizontal direction) of the plurality of UAVs 100 in the UAV group 100G, the movement in the horizontal direction of the plurality of UAVs 100 in the UAV group 100G causes more substantial change in the photographing range of the camera 220 of each of the plurality of UAVs 100. Thus, according to the pinch zoom-out operation or the pinch zoom-in operation, the terminal 80 can coarsely adjust the image scope of SA of the composite image generated based on the images photographed by the plurality of UAVs 100 at a high speed.

In addition, when the user performs the pinch zoom-out operation or the pinch zoom-in operation, the terminal controller 81 may not only detect the operation of the finger movement and the operation amount (operation range), but also detect a speed of the finger movement, through the operation device 83. When the terminal controller 81 detects the speed of the finger movement, the speed can be included in the instruction information transmitted to each of the plurality of UAVs 100 in the UAV group 100G, such that each of the plurality of UAVs 100 in the UAV group UAVG expands or contracts at a speed corresponding to the speed of the finger movement. Through the communication interface 150, the UAV controller 110 of each of the plurality of UAVs 100 in the UAV group 100G receives the instruction information. According to the received instruction information, the UAV controller 110 controls the gaps between the plurality of UAVs 100 to expand or contract at the speed corresponding to the speed of the finger movement. As such, in response to the operation by the user, the terminal 80 can arbitrarily change the speed at which the image scope SA of the composite image changes.

When the terminal controller 81 controls each of the plurality of UAVs 100 in the

UAV group 100G to move in the horizontal direction, the following restrictions may apply.

For example, when the UAV group 100G contracts, the terminal controller 81 instructs to control the flight of the plurality of UAVs 100 to ensure that the distances between the plurality of UAVs 100 are above a safe distance (e.g., approximately between 3 meters and 4 meters). That is, the distance between adjacent UAVs is above a threshold th1. As such, when the plurality of UAVs 100 move in the horizontal direction at the same time, the terminal 80 can still avoid excessive approximation and collision between adjacent UAVs 100.

For example, when the UAV group 100G expands, the terminal controller 81 instructs to control the flight of the plurality of UAVs 100 to ensure that the photographing ranges (the image scope of the photographed image) of the camera 220 or each of the plurality of cameras 230 of adjacent UAVs 100 at least partially overlap. That is, the distance between adjacent UAVs is below a threshold th2. As such, the plurality of images photographed by the plurality of UAVs 100 in the UAV group 100G are ensured to partially overlap to reliably generate the composite image.

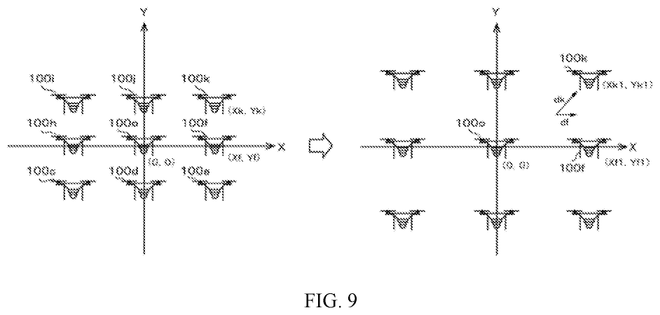

FIG. 9 is a schematic diagram showing an example of calculating a distance that each of the plurality of UAVs 100 moves when a user performs the pinch zoom-in operation and the pinch zoom-out operation to move each of the plurality of UAVs 100 in a horizontal direction consistent with the present disclosure.

As shown in FIG. 9, nine UAVs 100c-100k (100c, 100d, 100e, 100f, 100o, 100h, 100i, 100j, and 100k) are arranged to form rectangular grid points. FIG. 9 may be obtained when observing the UAV group 100G from the front or the back, or may be obtained when observing the UAV group 100G from directly above or directly below. The number of the plurality of UAVs 100 in the UAV group 100G is for illustration purpose, and may be other than nine.

In the nine UAVs 100c-100k, the position of the UAV 100o at the center has the coordinate (0, 0). With respect to the UAV 100o, the position of the UAV 100f at the right side has the coordinate (xf, yf). With respect to the UAV 100o, the position of the UAV 100k at the upper right corner has the coordinate (xk, yk). The position of the UAV 100o is one example of a reference point.

When the user performs the pinch zoom-out operation on the touch-control panel TP, the terminal controller 81 obtains the operation amount of the pinch zoom-out operation through the operation device 83. Based on the operation amount of the pinch zoom-out operation, the terminal controller 81 calculates movement amounts that the position of each of the nine UAVs 100c-100k moves respectively while still maintaining flight formation.

The flight formation refers to a shape formed by the plurality of UAVs in the UAV group 100G flying in the air and is determined by position relationship of the plurality of UAVs 100. The flight formation may be presented in a three-dimensional space or may be presented in a two-dimensional space. The shapes of the flight formation presented in the three-dimensional space may include a polygonal column shape, a polygonal pyramid shape, a sphere shape, an ellipsoid shape, and other three-dimensional shapes. The shapes of the flight formation presented in the two-dimensional space may include a polygon, a circle, an ellipsis, and other two-dimensional shapes.

According to the operation amount of the pinch zoom-out operation, the terminal controller 81 calculates an expansion ratio when the UAV group 100G expands. The relationship between the operation amount and the expansion ratio may be linear or non-linear. The expansion ratio may also be an expansion ratio between the distances of each of the plurality of UAVs 100 in the UAV group 100G with respect to the reference point before and after the movement. The terminal controller 81 may use the position to which each of the plurality UAVs 100 moves corresponding to the calculated expansion ratio to calculate the movement amount (expansion distance) from the position of each of the plurality of UAVs 100 before the movement. In addition, because each of the plurality of UAVs 100 has a different distance with respect to the reference point, the calculated expansion distance may be different for each of the plurality of UAVs 100. Thus, the expansion distance included in the instruction information transmitted to each of the plurality of UAVs 100 may be different for each of the plurality of UAVs 100.

In addition, for example, the terminal controller 81 calculates the movement amount df for the UAV 100f at the right side to move upward and the movement amount dk for the UAV 100k at the upper right corner to move upward. When the flight formation is a square and the flight formation is maintained, the relationship between the movement amount dk and the movement amount df can be represented in the equation (1).

movement amount dk=2^{1/2}*movement amount df (1)

where the power of (½) represents square root (\sqrt{ }), the asterisk (*) represents multiplication symbol. As shown in FIG. 9, the coordinate (xf1, yf1) represents the position of the UAV 100f after the movement, and the coordinate (xk1, yk1) represents the position of the UAV 100k after the movement.

In this case, the terminal controller 81 uses the center of the UAV group 100G as the reference point. The plurality of UAVs 100 expand away from the reference point or contract toward the reference point. The terminal controller 81 calculates the movement amount for each of the plurality of UAVs 100. In addition, the terminal controller 81 may not use the center of the UAV group 100G as the reference point and may use any position in the flight formation (e.g., the position of any of the plurality of UAVs 100) of the UAV group 100G as the reference point. In addition, when the flight formation of the UAV group 100G is a triangle, the reference point may be the center of gravity or the center of triangle. Further, the terminal controller 81 may allow the flight formation to change while calculating the position of each of the plurality of UAVs 100.

In addition, the terminal controller 81 may calculate the movement amount (contraction distance) for the pinch zoom-in operation in the same way as for the pinch zoom-out operation. Compared with the pinch zoom-out operation, for the pinch zoom-in operation, the UAV group 100G contracts instead of expanding.

As such, based on the pinch zoom-out operation or the pinch zoom-in operation, the terminal controller 81 instructs each of the plurality of UAVs 100 to move in the horizontal direction. The instruction is an example of the second movement instruction.

As a result, the terminal 80 controls the plurality of UAVs 100 to move in the horizontal direction by performing the change operation on the image scope SA. Compared with the movement in the altitude direction of the plurality of UAVs 100, the movement in the horizontal direction of the plurality of UAVs 100 causes more substantial change in the image scope Sa of the composite image. Thus, the movement in the horizontal direction of the plurality of UAVs 100 is desired for coarsely adjusting the image scope SA, and the adjustment can be fast. In addition, when the altitude movement of the plurality of UAVs 100 is restricted and the plurality of UAVs 100 is unable to move in the altitude direction, it is still possible to change the image scope SA.

In addition, as a result of horizontal movement of the plurality of UAVs 100, the terminal control module 81 may instruct to control the flight of the plurality of UAVs 100, such that the distance between any two adjacent UAVs remains the same. That is, as shown in FIG. 9, the gaps between the plurality of UAVs 100 in the UAV group 100G are the same.

As a result, the areas of the overlapping portions between the images photographed by the plurality of UAVs are unified and identical. Thus, the information amount contributed to the image scope SA in the composite image by each of the plurality of the photographed images is unified to the same extent, and the terminal 80 improves the image quality of the composite image.

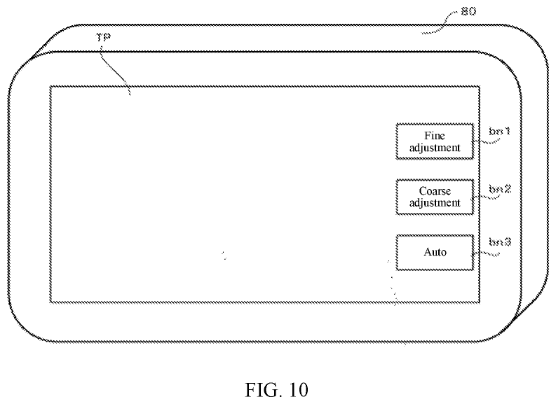

FIG. 10 is a schematic diagram showing an example configuration screen of an operation mode consistent with the present disclosure. As shown in FIG. 10, the operation screen of the touch-control panel TP and operation examples are illustrated. When being applied to the pinch zoom-out operation and the pinch zoom-in operation, the operation mode determines whether the plurality of UAVs 100 move in the altitude direction or move in the horizontal direction. The operation mode also includes a fine adjustment mode, a coarse adjustment mode, and an auto mode that automatically determines whether the fine adjustment mode or the coarse adjustment mode is applied.

The terminal controller 81 controls the touch-control panel TP to display a fine button bn1 for selecting the fine adjustment mode, a coarse button bn2 for selecting the coarse adjustment mode, and an auto button bn3 for selecting the auto mode. In the fine adjustment mode, as described in the first operation embodiment, the UAV group 100G ascends or descends to change the image scope SA of the composite image. In the coarse adjustment mode, as described in the second operation embodiment, the UAV group 100G expands or contacts to change the image scope SA of the composite image. In the auto mode, the terminal controller 81 automatically determines one of the fine adjustment mode and the coarse adjustment mode to change the image scope SA of the composite image.

When the terminal controller 81 determines one of the fine adjustment mode and the coarse adjustment mode in the auto mode, various constraints may be considered in the decision. The terminal controller 81 may obtain the constraint information and determines the fine adjustment mode for the auto mode based on the constraints.

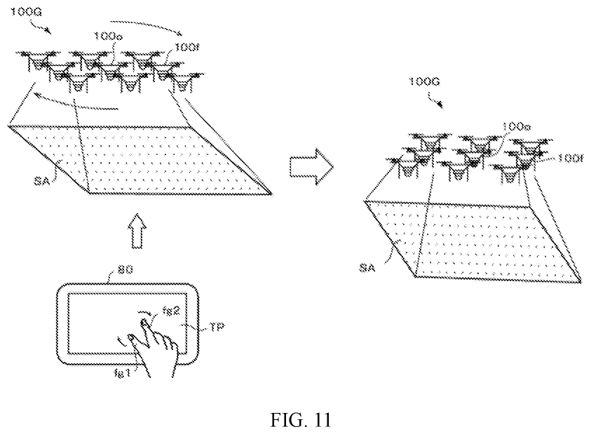

FIG. 11 is a schematic diagram showing an example of performing a twist operation on the touch-control panel TP to rotate the image scope SA of the composite image consistent with the present disclosure. In the example shown in FIG. 11, an operation for rotating the UAV group 100G around the reference point (e.g., the center of the UAV groups 100G) as the center point in the horizontal direction is illustrated. As shown in FIG. 11, each UAV 100 itself is not rotating (rotating of a UAV 100 itself is also known as self-rotating), but the UAV group 100G is rotating as a whole around the reference point (also known as revolving). The twist operation is one of the change operations for changing the image scope SA of the composite image. In addition, in the self-rotation of a UAV 100, the orientation (heading direction) of the UAV 100 changes but the UAV 100 does not move translationally.

The terminal controller 81 of the terminal 80 may control the UAV group 100G to revolve and control each of the plurality of UAVs 100 to self-rotate. When the UAV group 100G revolves and the UAVs 100 self-rotate, the contour of the image scope SA of the composite image does not change after the UAV group 100G revolves and rotates. For example, before the rotation, the flight formation of the UAV group 100G is a rectangular. After the rotation, the flight formation of the UAV group 100G is still the same rectangular. On the other hand, when the terminal controller 81 does not control each of the plurality of UAVs 100 to rotate, but controls the UAV group 100G to revolve, the contour of the image scope SA of the composite image may change after the UAV group rotates. For example, when the flight formation of the UAV group 100G is a rectangular, the flight formation of the UAV group 100G after the rotation may change to an approximate parallelogram.

In the twist operation, for example, the terminal controller 81 obtains information inputted at two positions of the touch-control panel TP at two time points, and obtains (e.g., calculates) a line connecting the two inputted positions at the two time points. The terminal controller 81 calculates an angle (i.e., rotation angle) formed between the two lines obtained at the two time points. When the calculated angle is above a threshold th4, the twist operation is detected.

The user performs the twist operation on the touch-control panel TP by twisting two fingers (e.g., the thumb fg1 and the index finger fg2) touching the touch-control panel TP. The terminal controller 81 detects the twist operation and the operation amount through the operation device 83. After detecting the pinch zoom-int operation, the terminal controller 81 calculates a rotation angle corresponding to the operation amount. The rotation angle represents an angle in which the UAV group 100G rotates before and after the rotation, that is, the angle that each of the plurality of UAVs 100 in the UAV group 100G rotates around the reference point as the center. For example, the greater the operation amount, the greater the rotation angle. The smaller the operation amount, the smaller the rotation angle.

Through the communication device 85, the terminal controller 81 transmits the instruction information for instructing to rotate by the calculated rotation angle to each of the plurality of UAVs 100 in the UAV group 100G. Through the communication interface 150, each of the plurality of UAVs 100 in the UAV group 100G receives the instruction information. According to the received instruction information, the UAV controller 110 drives the rotor mechanism 210 to move each of the plurality of UAVs 100, such that the UAV group 100G rotates around the reference point as the center by the rotation angle.

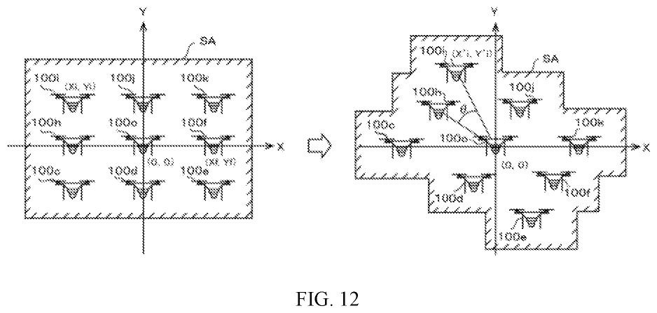

FIG. 12 is a schematic diagram showing an example of calculating a rotation angle rotated by the UAV group 100G corresponding to a twist operation by the user consistent with the present disclosure. The rotation angle θ may be, for example, an angle formed between a line connecting two points on the touch-control panel TP touched by the thumb fg1 and the index finger fg2 respectively before the operation (before the twist) and a line connecting two points on the touch-control panel TP touched by the thumb fg1 and the index finger fg2 respectively after the operation. The rotation angle θ may also be a value obtained by performing certain calculation (e.g., multiplied by a certain coefficient) on the angle formed between the two lines.

As shown in FIG. 12, similar to FIG. 9, nine UAVs 100c-100k (100c, 100d, 100e, 100f, 100o, 100h, 100i, 100j, and 100k) are arranged to form rectangular grid points. In the nine UAVs 100c-100k, the position of the UAV 100o at the center has the coordinate (0, 0). With respect to the UAV 100o, the position of the UAV 100i at the upper left corner has the coordinate (xi, yi).

In response to the twist operation performed by the user on the touch-control panel TP, the terminal controller 81 obtains the operation amount of the twist operation through the operation device 83. Based on the operation amount of the twist operation, the terminal controller 81 calculates the rotation angle θ. Based on the rotation angle θ, the terminal controller 81 calculates the coordinate (x′i, y′i) of the position to which the UAV 100i moves around the UAV 100o as the center. In this case, the terminal controller 81 performs the calculation according to the equation (2) using a rotation matrix:

$$[ \begin{matrix}{x}_{i}^{′} \\ {y}_{i}^{′}\end{matrix} ] = [ \begin{matrix}cos θ & sin θ \\ - s in θ & cos θ\end{matrix} ] [ \begin{matrix}{x}_{i} \\ {y}_{i}\end{matrix} ] \qquad ( 2 )$$

The terminal controller 81 transmits the instruction information for moving the plurality of UAVs 100 by rotating the UAV group 100G. In this case, through the communication device 85, the terminal controller 81 transmits the instruction information including the calculated post-rotation position coordinates of the plurality of UAVs 100 to the UAV group 100G. After the UAV controller 110 of each of the plurality of UAVs 100 receives the instruction information including the post-rotation position coordinate from the terminal 80 through the communication interface 150, the UAV controller 110 drives the rotor mechanism 210 to move the UAV 100 thereof to the received post-rotation position coordinate. As shown in FIG. 12, the image scope SA (indicated by diagonal lines) of the composite image generated based on the images photographed by the plurality of UAVs 100 in the UAV group 100G after the rotation is compared with the pre-rotation image scope SA, and is shifted to the area corresponding to the rotation angle θ, having an approximate parallelogram contour.

In addition, in response to the twist operation performed by the user, the terminal controller 81 not only detects the operation of the finger movement and the operation amount, but also detects the speed of the finger movement, through the operation device 83. After detecting the speed of the finger movement, the terminal controller 81 determines the rotation speed of the UAV group 100G based on the speed of the finger movement, and transmits the instruction information including the rotation speed to each of the plurality of UAVs 100. Through the communication interface 150, the UAV controller 110 of each of the plurality of UAVs 100 receives the instruction information. According to the received instruction information, the UAV controller 110 moves the UAV 100 thereof to rotate the UAV group 100G at the rotation speed of the UAV group 100G. As such, in response to the user's operation, the terminal 80 can arbitrarily change the speed at which the image scope SA of the composite image rotates.

In this way, the terminal controller 81 of the terminal 80 obtains the information of the twist operation (an example of the change operation) for rotating the image scope SA of the composite image, and based on the twist operation, controls the flight of each of the plurality of UAVs 100, such that the plurality of UAVs 100 rotate around the reference position while maintaining the position relationship between the plurality of UAVs 100 in the UAV group 100G, Thus, the terminal 80 rotates the image scope SA according to the twist operation by the user, and the image scope SA can be intuitively rotated in a manner desired by the user.

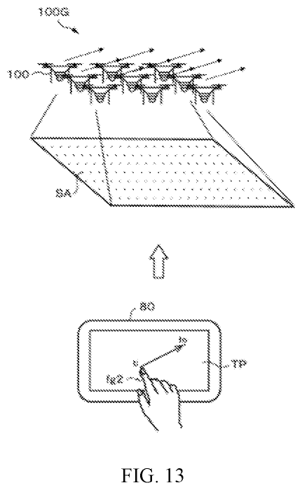

FIG. 13 is a schematic diagram showing an example of performing a sliding operation on the touch-control panel TP to move the UAV group 100G consistent with the present disclosure. In the example shown in FIG. 13, the operation for moving the UAV group 100G by a certain distance in a desired direction is illustrated. The sliding operation is one of the change operations for changing the image scope SA of the composite image.

In the sliding operation, for example, the terminal controller 81 obtains one position inputted on the touch-control panel TP at two time points. After detecting that the inputted position continuously changes between the two time points, the terminal controller 81 detects the sliding operation.

The user performs the sliding operation on the touch-control panel TP by touching with one finger (e.g., the index finger fg2). Through the touch-control panel TP, the terminal controller 81 detects the sliding operation and the operation amount based on a starting point ti and an ending point to touched by the index finger fg2. After detecting the sliding operation, the terminal controller 81 calculates a movement distance of each of the plurality of UAVs 100 corresponding to the operation amount. The movement distance may be a movement distance that each of the plurality of UAVs 100 moves in the horizontal direction. The movement distance for each of the plurality of UAVs 100 may be the same. For example, the greater the operation amount, the longer the movement distance. The smaller the operation amount, the shorter the movement distance.

In addition, the terminal controller 81 determines a movement direction for each of the plurality of UAVs 100 corresponding to the sliding operation. Based on the position of the touch starting point ti and the position of the touch ending point to on the touch-control panel TP, the terminal controller 81 determines the movement direction for each of the plurality UAVs 100. For example, the terminal controller 81 may set a direction from the position corresponding to the touch starting point ti in the real space to the position corresponding to the touch ending point to in the real space as the movement direction for each of the plurality of UAVs 100. As a result, the position of the target object displayed on the touch-control panel TP moves in a direction opposite to the movement direction for each of the plurality of UAVs 100.

Through the communication device 85, the terminal controller 81 transmits the instruction information for instructing the movement by the calculated movement distance and movement direction to the UAV group 100G. Through the communication interface 150, the UAV controller 110 of each of the plurality of UAVs 100 in the UAV group 100G receives the instruction information. According to the received instruction information, the UAV controller 110 drives the rotor mechanism 210 to move the UAV 100 thereof by the movement distance in the movement direction corresponding to the sliding operation. In this case, because each of the plurality of UAVs 100 in the UAV group 100G moves by the same movement distance in the same movement direction, the size of the image scope SA of the composite image does not change. However, the geographic area included in the image scope SA changes (moves).

In addition, in response to the sliding operation performed by the user, the terminal controller 81 not only detects the operation of the finger movement and the operation amount, but also detects the speed of the finger movement, through the operation device 83. After detecting the speed of the finger movement, the terminal controller 81 transmits the instruction information including the movement speed to each of the plurality of UAVs 100 in the UAV group 100G. Through the communication interface 150, the UAV controller 110 of each of the plurality of UAVs 100 receives the instruction information. According to the received instruction information, the UAV controller 110 moves the UAV 100 thereof at an initial speed corresponding to the speed of the finger movement. As such, in response to the user's operation, the terminal 80 can arbitrarily change the speed at which the image scope SA of the composite image changes. In addition, based on the sliding operation, the plurality of UAVs 100 initially moves at the initial speed. After receiving acceleration in the direction opposite to the movement direction, the movement of the plurality of UAVs 100 slows down. Thus, the movement distance may be longer than the distance between the position in the real space corresponding to the touch starting point ti displayed on the touch-control panel TP and the position in the real space corresponding to the touch ending point to displayed on the touch-control panel TP.

As such, the terminal controller 81 of the terminal 80 obtains the information of the sliding operation (an example of the change operation) for moving the image scope SA of the composite image in the horizontal direction to another geographic area. Based on the sliding operation, the terminal controller 81 instructs to control the flight (moving in the horizontal direction) of the plurality of UAVs 100. In response to the operation by the user, the terminal 80 can arbitrarily change the geographic area of the image scope SA. Thus, the image scope SA of the composite image can be intuitively moved in a manner desired by the user.

In the following, the operation of an aircraft group control system 10 will be described.

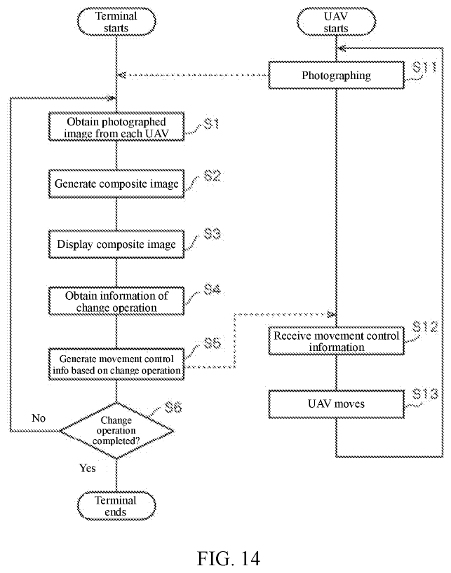

FIG. 14 is a schematic diagram showing an operation sequence of the terminal 80 and each of the plurality of UAVs 100 consistent with the present disclosure. As shown in FIG. 14, the operation for changing the image scope SA of the UAV group 100G when the UAV group 100G is flying and photographing is illustrated. Here, the operation of the plurality of UAVs 100 includes the movement of the plurality of UAVs 100.

At each of the plurality of UAVs 100, the UAV controller 110 controls the camera 220 to photograph the target object (e.g., on the ground) during flight, and transmits the image data of the photographed images to the terminal 80 (at S11) through the communication interface 150.

At the terminal 80, the terminal controller 81 receives the obtained image data (at S1) from the communication device 85 of each of the plurality of UAVs 100. In addition, the terminal controller 81 also receives the addition information related to the photographed images from the communication device 85 of each of the plurality of UAVs 100. The additional information includes the photographing range information of the photographed images. The terminal controller 81 combines the images photographed by the plurality of UAVs 100 to generate the composite image (at S2). In addition, based on the photographing range information obtained from each of the plurality of UAVs 100, the terminal controller 81 calculates the image scope SA of the composite image. The terminal controller 81 displays the composite image on the touch-control panel TP (at S3).

Through the touch-control panel TP, the terminal controller 81 obtains the information of the change operation for changing the image scope SA (at S4). The change operation includes, for example, the pinch zoom-out operation, the pinch zoom-in operation, the twist operation, and the sliding operation. Based on the change operation, the terminal controller 81 generates movement control information for controlling the movement of each of the plurality of UAVs 100, and transmits the generated movement control information to each of the plurality of UAVs 100 (at S5). The movement control information corresponds to, for example, the above-described instruction information.

The terminal controller 81 determines whether the change operation for changing the mage scope SA is completed (at S6). Whether the change operation is completed may be determined by determining whether the operation by the user of the change operation on the touch-control panel TP is completed, or may be determined by determining whether the finger of the user touching the touch-control panel TP for the change operation is removed from the touch-control panel TP. Before the change operation is completed, the terminal controller 81 returns to the processing at S1. After the change operation is completed, the terminal controller 81 ends the operation.

In each of the plurality of UAVs 100, the UAV controller 110 receives the movement control information from the terminal 80 through the communication interface 150 (at S12). The UAV controller 110 drives the rotor mechanism 210 to move the UAV 100 thereof to the position based on the movement control information (at S13). Then, the UAV controller 110 returns to the processing at S11.

In this way, the terminal controller 81 of the terminal 80 obtains the plurality of images (an example of the first photographed images) photographed by the plurality of UAVs 100. The terminal controller 81 combines the plurality of images to generate the composite image (an example of the first composite image). The terminal controller 81 obtains the information of the change operation for changing the image scope SA of the composite image (an example of the first image scope). Based on the change operation, the terminal controller 81 instructs to control the flight of each of the plurality of UAVs 100.

In some embodiments, based on the change operation, the terminal 80 instructs each of the plurality of UAVs 100 in the UAV group to move. For example, compared with changing the image scope by using a digital focus function of the camera 220 of each of the plurality of UAVs 100 to photograph the images without moving any of the plurality of UAVs 100, the terminal 80 can suppress quality degradation of the photographed images. Thus, the terminal can also suppress the quality degradation of the composite image combining the plurality of photographed images. In addition, in response to the operation by the user, the terminal 80 instructs to change the image scope SA of the composite image by intuitively moving the plurality of UAVs 100.

In addition, the information of the change operation includes a category of the change operation (e.g., any one of the pinch zoom-out operation, the pinch zoom-in operation, the twist operation, and the sliding operation) and the operation amount of the change operation. The terminal controller 81 calculates the image scope SA, and calculates the image scope SA2 (an example of the second image scope) based on the image scope SA, the category of the change operation, and the operation amount of the change operation. Based on the change operation, the terminal controller 81 instructs to control the flight of each of the plurality of UAVs 100, such that the image scope of the composite image (an example of the second composite image) generated based on the plurality of images (an example of the second photographed images) photographed by the plurality of UAVs 100 that have been moved becomes the image scope SA2. In this case, based on, for example, the operation amount of the change operation, the terminal controller 81 determines the movement amount or the rotation angle for each of the plurality of UAVs 100. Based on the image scope SA before the change and the determined movement amount or the rotation angle, the terminal controller 81 derives the image scope SA2 after the change.

In some embodiments, the terminal 80 uses the operation amount of the change operation anticipated by the user to instruct to control the flight of each of the plurality of UAVs 100, thereby changing the image scope SA of the composite image as anticipated by the user, and intuitively moving the plurality of UAVs 100.

In addition, as shown in FIG. 14, at S5, based on the change operation, the terminal controller 81 generates and transmits the movement control information. At S6, before the change operation is completed, the terminal controller 81 repeats the processing of S5 to generate and transmit the movement control information based on the change operation. That is, before the change operation is completed, the terminal controller 81 repeatedly instructs to control the flight of each of the plurality of UAVs 100 based on the change operation.

In some embodiments, at the same time the change operation continues, the terminal 80 instructs to move each of the plurality of UAVs 100 sequentially. The terminal 80 sequentially displays the composite image generated based on the images photographed by the plurality of UAVs 100 that have already been moved. The user can directly confirm whether the desired composite image has been obtained by looking at the displayed composite image and determine when to end the change operation. In addition, the terminal 80 can rapidly move the UAV group 100G rather than moving some of the plurality of UAVs 10 and waiting for the completion of the change operation.

In some other embodiments, the terminal controller 81 may instruct to control the flight of each of the plurality of UAVs 100 based on the change operation after the information of the change operation is obtained.

In some embodiments, after the change operation is completed, the terminal 80 moves the plurality of UAVs 100 altogether. Compared with sequentially moving each of the plurality of UAVs 100 during the change operation, the terminal 80 reduces the amount of data communicated between the terminal 80 and the plurality of UAVs 100, thereby reducing network traffic load.

Various embodiments of the present disclosure are used to illustrate the technical solution of the present disclosure, but the scope of the present disclosure is not limited thereto. Although the present disclosure has been described in detail with reference to the foregoing embodiments, those skilled in the art should understand that the technical solution described in the foregoing embodiments can still be modified or some or all technical features can be equivalently replaced. Without departing from the spirit and principles of the present disclosure, any modifications, equivalent substitutions, and improvements, etc. shall fall within the scope of the present disclosure. The scope of invention should be determined by the appended claims.

The execution order of processing such as operations, procedures, stapes, and phases in the devices, systems, programs, and methods shown in the claims, the specification, and the drawings can be implemented in any order unless terms such as “before” and “prior to” are used specifically, or an output of a former process is used in a latter process. Regarding the operation sequence in the claims, the specification, and the drawings, terms such as “first” and “next” are used for convenience, but this does not mean that they must be implemented in this order.

In the embodiments of the present disclosure, the plurality of UAVs 100 in the UAV group 100G are primarily photographing the ground from above (i.e., along the direction of gravity). In addition, the plurality of UAVs 100 may photograph in a direction other than the direction of gravity. For example, the plurality of UAVs 100 in the UAV group 100G may be arranged in the direction of gravity to photograph an object in the horizontal direction, or may be arranged at an angle with respect to either direction of gravity or the horizontal direction Both are applicable in the embodiments of the present disclosure. In this case, the movement (when photographing the ground) in the direction of gravity (the altitude direction) becomes the movement in the direction of the target object, i.e., the photographing direction, and the movement in the horizontal direction becomes the movement in the direction perpendicular to the photographing direction.

What is claimed is:

1. An information processing device comprising:
a processor; and
a memory storing a program that, when executed by the processor, causes the processor to:
obtain a plurality of images photographed by a plurality of aircrafts;
combine the plurality of images to generate a composite image;
obtain information of a change operation for changing an image scope of the composite image; and
control flight of the plurality of aircrafts based on the change operation.

2. The information processing device of claim 1, wherein:
the information of the change operation includes a category of the change operation and an operation amount of the change operation;
the images are first images, the composite image is a first composite image, and the image scope is a first image scope;
the program further causes the processor to:
calculate the first image scope;
calculate a second image scope based on the first image scope, the category of the change operation, and the operation amount of the change operation; and
control the plurality of aircrafts to photograph a plurality of second images, a second composite image generated based on the plurality of second images having the second image scope.

3. The information processing device of claim 1, wherein:
the change operation includes an operation to change a size of the image scope; and
the program further causes the processor to generate a movement instruction based on the change operation for instructing the plurality of aircrafts to move in a direction perpendicular to a horizontal direction.

4. The information processing device of claim 3, wherein the program further causes the processor to:
process the movement instruction to control each of the plurality of aircrafts to move by a same distance.

5. The information processing device of claim 1, wherein:
the change operation includes an operation to change a size of the image scope; and
the program further causes the processor to generate a movement instruction based on the change operation for instructing the plurality of aircrafts to move in a horizontal direction.

6. The information processing device of claim 5, wherein the program further causes the processor to:
process the movement instruction to control the plurality of aircrafts to move while keeping any two adjacent ones of the plurality of aircrafts separated by a same gap.

7. The information processing device of claim 5, wherein the program further causes the processor to:
process the movement instruction to control the plurality of aircrafts to move while keeping any two adjacent ones of the plurality of aircrafts separated by at least a gap greater than a threshold.

8. The information processing device of claim 5, wherein the program further causes the processor to:
process the movement instruction to control the plurality of aircrafts to move, such that image scopes of images photographed by any two adjacent ones of the plurality of aircrafts at least partially overlap.

9. The information processing device of claim 3, wherein:
the change operation includes an operation to change a size of the image scope; and
the program further causes the processor to determine whether to perform a first movement instruction to instruct the plurality of aircrafts to move in a direction perpendicular to a horizontal direction or to perform a second movement instruction to instruct the plurality of aircrafts to move in the horizontal direction.

10. The information processing device of claim 9, wherein the program further causes the processor to:
determine whether to perform the first movement instruction or the second movement instruction based on constraint information for a flight area in which the plurality of aircrafts fly.

11. The information processing device of claim 9, wherein the program further causes the processor to:
obtain information of a selection operation; and
determine whether to perform the first movement instruction or the second movement instruction based on the selection operation.

12. The information processing device of claim 1, wherein:
the change operation includes an operation to rotate the image scope; and
the program further causes the processor to instruct the plurality of aircrafts based on the change operation to maintain a position relationship among the plurality of aircrafts while rotating around a reference position.

13. The information processing device of claim 1, wherein:
the change operation includes an operation to move the image scope in a horizontal direction to another geographic area; and
the program further causes the processor to instruct the plurality of aircrafts to move based on the change operation.

14. The information processing device of claim 1, wherein the program further causes the processor to:
before obtaining the information of the change operation is completed, repeatedly executes flight control instruction to control the plurality of aircrafts based on the change operation.

15. The information processing device of claim 1, wherein the program further causes the processor to:
after obtaining the information of the change operation is completed, instruct the plurality of aircrafts to fly based on the change operation.

16. A flight control method comprising:
obtaining a plurality of images photographed by a plurality of aircrafts;
combining the plurality of images to generate a composite image;
obtaining information of a change operation for changing an image scope of the composite image; and
controlling a flight of the plurality of aircrafts based on the change operation.

17. The flight control method of claim 16, wherein:
the information of the change operation includes a category of the change operation and an operation amount of the change operation;
the images are first images, the composite image is a first composite image, and the image scope is a first image scope; and
controlling the flight of the plurality of aircrafts includes:
calculating a second image scope based on the first image scope, the category of the change operation, and the operation amount of the change operation; and
controlling the plurality of aircrafts to photograph a plurality of second images, a second composite image generated based on the plurality of second images having a second image scope.

18. The flight control method of claim 16,
wherein the change operation includes an operation to change a size of the image scope; and
the method further comprising:
generating a movement instruction based on the change operation for instructing the plurality of aircrafts to move in a direction perpendicular to a horizontal direction.

19. The flight control method of claim 18, further comprising:
processing the movement instruction to control each of the plurality of aircrafts to move by a same distance.

20. A computer readable recording medium storing a program that, when executed by an information processing device, causes the information processing device to:
obtain a plurality of images photographed by a plurality of aircrafts;
combine the plurality of images to generate a composite image;
obtain information of a change operation for changing an image scope of the composite image; and
control flight of the plurality of aircrafts based on the change operation.
